(19) United States
(12) Patent Application Publication
(10) Pub. No.: US 2009/0003820 A1
(43) Pub. Date: Jan. 1, 2009

(54) Strap for Cameras and Video Recorders

(76) Inventors: David Law, Seattle, WA (US); Graeme Esarey, Seattle, WA (US)

Correspondence Address: MAXVALUEIP CONSULTING, 11204 ALBERMYRTLE ROAD, POTOMAC, MD, 20854, US

(21) Appl. No.: 11/772,224

(22) Filed: Jul. 1, 2007

(51) Int. Cl. G03B 17/00

(52) U.S. Cl. 396/423

(57) ABSTRACT

As one example, it features: “Gel Strap”: It is a removable strap, whose position or length can be adjusted at the gel pads, by the user, to provide an optimal and personalized comfort solution. It also features: “Male-female plug strap”, for connectivity for electricity, data, Internet, network, computer, wired or wireless, transfer of data, printing, provisioning, upgrading, uploading, downloading, synchronization, automatic backup, security, tel., or text messaging. Another example is: Adjusting the strap length and size from the body section of the strap: Straps generally have a padded (fatter) section and then smaller straps at the 2 ends, which attach to the camera. Previously, the length of the strap was adjusted at the ends of the smaller straps, near the camera. However, here, in this disclosure, in one of the examples, the adjustment is done in the body of the center-padded section. This allows the ends of the strap to be clean and uncluttered, and the adjustment is hidden in the fat padded area of the strap, for a better look and more security. These can apply to other devices, as well. More examples are given in the specification.

### RELATED APPLICATIONS

This application is related to the following co-pending applications, with some common inventors, and same exact assignee: (The teaching of all the applications below are incorporated herein by reference).

U.S. applic. Ser. No. 11/695,625, filed Apr. 3, 2007.

U.S. applic. Ser. No. 11/696,740, filed Apr. 5, 2007.

U.S. applic. Ser. No. 11/695,624, filed Apr. 3, 2007.

### BACKGROUND

The strap for cameras or video recorders is a very important feature, which can utilize other functionalities, as well, as explained below in this invention. For example, it features: “Gel Strap”: It is a removable strap, whose position or length can be adjusted at the gel pads, by the user, to provide an optimal and personalized comfort solution.

Some of the related prior art are listed here:
Kawakami, U.S. Pat. No. 6,941,066, teaches a camera case for stopping degradation of picture quality, even if pictures are taken with a camera still in the case. Also, this invention provides a camera case with which it is possible to smoothly remove a strap from the case body. For example, a bent section is provided in a case body. Even if light emitted from a flash enters a thickened part of the case body, the light is diverged to the outside by the bent section. In this way, the amount of light transmitted from the flash to the lens of the camera is reduced. Further, a rib may be provided in the case body. In this way, light emitted from the flash and reflected by the inner surface of the case body is inhibited from reaching the lens of the camera. A strap is also supported by support pieces. If a strong tensile force is applied to the strap, the support pieces are deformed and the strap and the case body are separated.
Kawazura, U.S. Pat. No. 6,644,872, teaches an adapter having a plug, a jack, and a flexible cable, which connects the plug and the jack. The plug is connected to a socket provided in a camera body. The jack is connected to a camera accessory, which is a release switch device, for example. The jack is provided with a clip which is fixed to a strap attaching ring provided on the camera body or a strap attached to the strap attaching ring.
Solomon, U.S. Pat. No. 6,064,823, teaches a camera housing comprising a front cover part and a rear cover part, characterized in that the front cover part and the rear cover part have respective similar ends that are uniformly curved to be contoured in similar non-varying curves and have respective concavities that extend inward at the similar ends to define a concave surface common to the ends, and the end of at least one of the front and rear cover parts continues over the concavity at that end, in contour with the non-varying curves, to form a carry strap retainer which, with the single concave surface, defines a pass-through opening for an elongate carry strap.

However, none of the above teaches the features of the current application and invention, as described below.

### SUMMARY

As one example/embodiment, it features: “Gel Strap”: It is a removable strap, whose position or length can be adjusted at the gel pads, by the user, to provide an optimal and personalized comfort solution.

It also features: “Male-female plug strap”, for connectivity for electricity, data, Internet, network, computer, wired or wireless, transfer of data, printing, provisioning, upgrading, uploading, downloading, synchronization, automatic backup, security, tel., or text messaging.

Another embodiment is: Adjusting the strap length and size from the body section of the strap: Straps generally have a padded (fatter) section and then smaller straps at the 2 ends, which attach to the camera. In the prior art, the length of the strap is adjusted at the ends of the smaller straps, near the camera. However, here, in this invention, in one of the embodiments, the adjustment is done in the body of the center-padded section. This allows the ends of the strap to be clean and uncluttered, and the adjustment is hidden in the fat padded area of the strap, for a better look and more security. Another advantage is that the adjustment has to be done only once from center, rather than twice from the two ends, which is the conventional method.

The same concept can be applied to the video recorder, other electronics, or other objects, which may need a strap, for hanging, for example, from the neck, hand, backpack, briefcase, suitcase, hook, coat hanger, or for similar situations.

It could apply to phone, PDA, and GPS systems or devices.

### BRIEF DESCRIPTION OF THE DRAWINGS

FIG. 1 shows length adjustment done in the middle of the strap. In one embodiment, custom secure clips are attached to the camera strap mount.

FIG. 2 shows the electronics, cable, Bluetooth, cards, memory (sometimes hidden), flat ribbon, and curly cable, to be ready for use on this assembly.

### DETAILED DESCRIPTION OF THE PREFERRED EMBODIMENTS

To customize for one model and one person, all of the parameters are predetermined. However, in another embodiment, to apply this to 2 or more people or models, we need to have an adjustable and flexible strap. For example, the length can be adjusted using: a string, chain, rubber, elastic band, cable, ribbon, tether, adjustable belt, flexible material, stretchable material, strip (e.g. using nylon, metal, or cotton material), wrapped around a small pulley, Velcro, hook and loop, or a wheel with a groove, sometimes hidden, sometimes visible to the eye, sometimes using an anchor or hook, sometimes with a spring action, either pulling it some of the times or all of the times, sometimes with a lock or latch, to stop or secure the band (and its length constant), once it gets adjusted by the user.

In another embodiment, the spring action is free to move in one direction, but stopped with a latch on the opposite direction. For example, stretching or increasing the length is doable with no effort, but shortening the length of the strap requires the release of the latch or lock by the user, so that the pulley can move in the other direction, as well.

In one embodiment, the design is the same as the step motors or an elevator, in which the motor can move in one direction, in discrete steps or angles, but has a brake on the opposite direction.

To attach to a new camera or device, one can use a hook, chain, band, loop, tie, knot, join, bind, tether, magnet, electromagnet, or similar attaching means (as a general or universal method of connection).

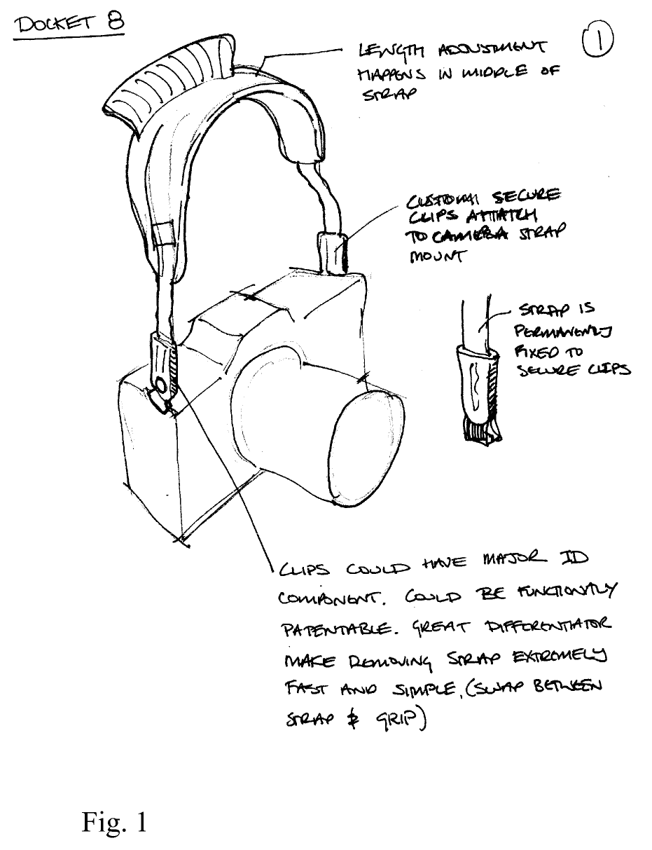

FIG. 1 shows length adjustment done in the middle of the strap. In one embodiment, custom secure clips are attached to the camera strap mount. In one embodiment, the strap is permanently fixed to secure clips. In one embodiment, the adjustment of the length is done inside a pocket area, not visible to the eye. In one embodiment, the adjustment is done on the outside of the strap, visible to the eye. In one embodiment, the clips have major ID component. In one embodiment, removing the strap is very easy and fast (swap between strap and grip (or latch or lock)).

In one embodiment, the strap has multiple layers. In one embodiment, the strap is embedded with a wire, cable, net, metal mesh, chain, or string, for stronger strap, for better security, longevity, or safety of the camera. For example, it cannot be readily cut by a thief. In one embodiment, it can have a GPS for tracking the thief or lost purse or camera (or the like). In one embodiment, it is embedded with the soft and flexible material.

In one embodiment, it is embedded in multiple pieces such that pieces can move to some extent and range with respect to each other, but still connected to each other, making the length of the strap still flexible (despite the metal or chain embedded in them, for strength purposes). That is, each piece connected to another piece like a chain, but each piece can move to left or right within the constraint of the neighboring pieces, limiting the range of the motion of each piece. In one embodiment, the pieces are folded together to reduce the length to minimum size, or pulled out to maximize the length. In one embodiment, the pieces are stored circular, like a pulley. In one embodiment, the pieces are stored overlapping each other, on top of another, like a stack of paper on top of each other.

In one embodiment, it is waterproof. In one embodiment, it is weather proof. In one embodiment, one can add different designs, text, and patterns inside or outside of the strap, for decoration, advertisement, instructions, or convenience of the user. In one embodiment, it has one piece. In one embodiment, it has multiple pieces.

In one embodiment, the strap is made of one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band network, net-shape material, magnetic material, metallic material, metallic chain, array of metallic rings, multi-dimensional structure, folded structure, hinges, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any similar, compound, chemical, or composite material.

In one embodiment, the strap includes (in, attached to, or on it) one or more of the following items: a picture frame, clock, notebook, calculator, solar cell array, battery, pen holder, pen, pencil, magnetic plate, magnetic decoration, light, LED, LCD, display, small TV, small radio, thermometer, pressure gauge, biometric sensor, thumb/fingerprint recognition module, combination lock, lock, Velcro, hook-and-loop, password entry input, small keyboard, input device, mouse, stylus, or sensitive screen, pointing device, speaker, microphone, small telephone set, keychain ring, hook (for hanging the unit), small video game, music player, downloading unit (from Internet or satellite), wireless unit, communication unit, antenna, small computer, small web browser, recorder, or any other electronic or mechanical device, apparatus, system, toy, decoration, or equipment.

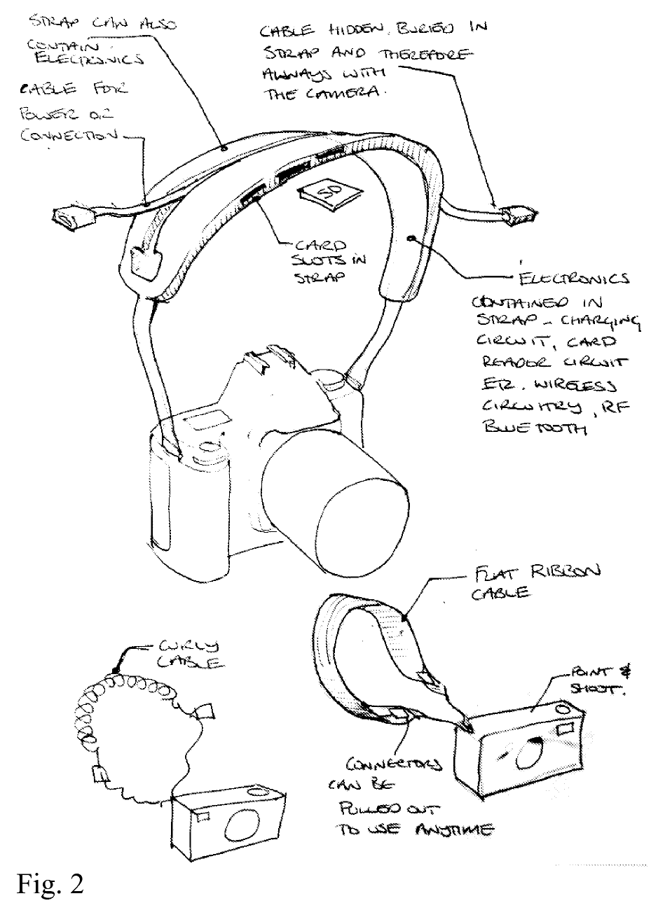

FIG. 2 shows the electronics, cable, Bluetooth, cards, memory (sometimes hidden), flat ribbon, and curly cable, to be ready for use on this assembly.

### Inflatable Strap

In one embodiment, the strap comprises multiple layers. In one embodiment, the strap is inflatable. In one embodiment, the strap cover is inflated using one or more of the following, or combination or mixture of the following: gas, liquid, solid, dust, gel-type, liquidated-solid, pressurized fluid, water-absorbent sponge, sponge-type material, or any expandable solid, liquid, fluid, chemical, gas, or material, caused by chemical reaction, heat, temperature variation, catalyst, chain reaction, exceeding critical mass, seed material, mixing, or pressure.

In one embodiment, the size or shape of said strap cover is adjusted based on the size, model, or type of the camera. In one embodiment, the inflation is adjusted based on the size, model, or type of the camera, or user's preference.

### SUMMARY OF SOME OF THE EMBODIMENTS

The strap comprises a connectivity means or apparatus for one or more of the following: male or female plug, electricity, data, Internet, network, computer, wired, wireless, transfer of data, printing, provisioning, upgrading, uploading, downloading, synchronization, automatic backup, backup, antenna, security, telephone, video download, music transfer, USB format, Ethernet, or text messaging.
A strap comprises embedded steel or metal wire, mesh, cable, net, or chain.
A strap comprises one or more of the following: security component, biometrics sensor or scanner, password verifier, lock, or chain.
A mechanism, device, section, or part for adjusting the length of strap, which is hidden to the eyes.
A system connected to a pump, gas tank, one-way valve, or pressure-release valve.
A strap comprises an antenna for cell phone, radio, GPS, pager, communication device, tracking device, or satellite connection.
A strap comprises multiple layers.
A strap comprises a waterproof material.
A strap comprises a light meter.
A strap containing a bag, wherein said bag is folded away inside said strap, or confined in a zipper within said strap. The bag holds said camera or video recorder, or the accessories for said camera or video recorder.
A strap comprises memory or storage to download or store the content captured by said camera or video recorder in real-time, or make a backup copy of the content previously captured by said camera or video recorder.
The download can be automatic, periodical, randomly, or based on a criteria. It can be based on wired or wireless. It can be erasing the duplication content, on the camera, as it takes the backup, to release the needed memory for future image capture by the camera, or video by the video recorder.
A strap comprises cells to store solar energy or electromagnetic radiation energy, to energize or supply electricity to said camera or video recorder (or other equipment, or just charge up a battery for future use).
A strap has its own light or flash light.
A strap with its own night vision goggle.
A strap comprises a speaker, microphone, voice recognition module, speaker recognition module, pager, satellite telephone, or cell phone.

Any other variation of the above teaching is also meant to be protected by the current patent.

1. A strap for a camera or video recorder,
wherein said strap comprises a mechanism, device, section, or part,
wherein said mechanism, device, section, or part adjusts said strap's length,
wherein said mechanism, device, section, or part is located in or about the middle section of said strap's length, and
wherein said strap comprises a connectivity means or apparatus for one or more of the following:
male, female, or hermaphroditic plug, electricity, data, Internet, network, computer, wired, wireless, transfer of data, printing, provisioning, upgrading, uploading, downloading, synchronization, automatic backup, backup, antenna, security, telephone, video download, music transfer, USB format, Ethernet, satellite connection, or text messaging.

2. A strap for a camera or video recorder, as recited in claim 1, wherein said strap comprises steel or metal wire, mesh, cable, net, or chain.

3. A strap for a camera or video recorder, as recited in claim 1, wherein said strap comprises embedded steel or metal wire, mesh, cable, net, or chain.

4. A strap for a camera or video recorder, as recited in claim 1, wherein said strap comprises one or more of the following: security component, biometrics sensor or scanner, password verifier, lock, or chain.

5. A strap for a camera or video recorder, as recited in claim 1, wherein said mechanism, device, section, or part is hidden to the eyes.

6. A strap for a camera or video recorder, as recited in claim 1, wherein said strap is inflatable.

7. A strap for a camera or video recorder, as recited in claim 1, wherein said strap comprises or connected to a pump, gas tank, one-way valve, or pressure-release valve.

8. A strap for a camera or video recorder, as recited in claim 1, wherein said strap comprises an antenna for cell phone, radio, TV, GPS, pager, communication device, tracking device, or satellite connection.

9. A strap for a camera or video recorder, as recited in claim 1, wherein said strap comprises multiple layers.

10. A strap for a camera or video recorder, as recited in claim 1, wherein said strap comprises a waterproof material.

11. A strap for a camera or video recorder, as recited in claim 1, wherein said strap comprises a bag.

12. A strap for a camera or video recorder, as recited in claim 11, wherein said bag is folded away inside said strap, or confined in a zipper within said strap.

13. A strap for a camera or video recorder, as recited in claim 11, wherein said bag holds said camera or video recorder.

14. A strap for a camera or video recorder, as recited in claim 11, wherein said bag holds the accessories for said camera or video recorder.

15. A strap for a camera or video recorder, as recited in claim 1, wherein said strap comprises memory or storage to download or store the content captured by said camera or video recorder in real-time.

16. A strap for a camera or video recorder, as recited in claim 1, wherein said strap comprises memory or storage to download, store, or make a backup copy of the content previously captured by said camera or video recorder.

17. A strap for a camera or video recorder, as recited in claim 1, wherein said strap comprises cells to store solar energy or electromagnetic radiation energy.

18. A strap for a camera or video recorder, as recited in claim 1, wherein said strap comprises cells to store solar energy or electromagnetic radiation energy, to energize or supply electricity to said camera or video recorder.

19. A strap for a camera or video recorder, as recited in claim 1, wherein said strap is made of or comprises one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band network, net-shape material, magnetic material, metallic material, metallic chain, array of metallic rings, multi-dimensional structure, folded structure, hinges, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any similar material, compound, chemical, or composite material.

20. A strap for a camera or video recorder, as recited in claim 1, wherein said strap comprises a speaker, microphone, voice recognition module, speaker recognition module, pager, satellite telephone, keyboard, stylus, input device, mouse, or cell phone.

21. A strap for a camera, video recorder, PDA, GPS, or phone,
wherein said strap comprises a mechanism, device, section, or part,
wherein said mechanism, device, section, or part adjusts said strap's length, and
wherein said mechanism, device, section, or part is located in or about the middle section of said strap's length.
